(19) United States
(12) Patent Application Publication
(10) Pub. No.: US 2016/0133213 A1
(43) Pub. Date: May 12, 2016

(54) LIQUID CRYSTAL DISPLAY AND DRIVING METHOD OF THE SAME

(71) Applicant: ILI TECHNOLOGY CORP., HSINCHU COUNTY (TW)

(72) Inventors: BOU-CHING FUNG, HSINCHU CITY (TW); CHING-RONG CHANG, HSINCHU COUNTY (TW)

(21) Appl. No.: 14/621,356

(22) Filed: Feb. 12, 2015

(30) Foreign Application Priority Data
Nov. 12, 2014 (TW) 103139254

(51) Int. Cl. G09G 3/36

(52) U.S. Cl. CPC G09G 3/3655; G09G 2310/08; G09G 2320/0252; G09G 2330/021; G09G 2300/0814; G09G 2300/0819; G09G 2300/0876

(57) ABSTRACT

A liquid crystal display and a driving method of the same are provided, and which drive scanning lines and data lines by a timing controller. When writing data signals to a liquid crystal capacitor, the timing controller controls a source driving circuit to provide the data signals to each data line, and control a gate driving circuit to generate a high-voltage signal to each scanning line in sequence. The high-voltage signals of two adjacent scanning lines overlap. When the high-voltage signals overlap, the timing controller transmits the data signal to each liquid crystal capacitor sequentially. After finishing writing data signals to the liquid crystal capacitor, the timing controller controls the gate driving circuit to generate a pulse signal to each scanning line continuously. The pulse signals generated by the scanning lines do not overlap. Accordingly, it can avoid the leakage of data signal stored in the liquid crystal capacitors.

### BACKGROUND

1. Technical Field

The present disclosure relates to a liquid crystal display and a driving method of the same, in particular, to a liquid crystal display with the low power consumption and a driving method of the same.

2. Description of Related Art

As liquid crystal displays advance, the liquid crystal display with the low power consumption becomes inevitably necessary, especially for adapting to the miniaturized electronic device, such as the electronic tag, smart phone, tablet computer, etc. The power consumption of the liquid crystal display directly affects the endurance of the whole electronic device.

Generally speaking, the liquid crystal display has a frame rate, and the frequency of the frame rate is around 50-70 Hz, i.e., 50-70 frames per second. When a user wants to get the liquid crystal display having lower power consumption, decreasing the frame rate is effective, for example, the frame rate decrease from 60 Hz to 1 Hz. However, although the lower frame rate can reduce the power consumption, but thin-film-transistor (TFT) of the liquid crystal display will cause the issue of negative gate bias stress.

To address the above issues, the inventor strives via associated experience and research to present the instant disclosure, which can effectively improve the limitation described above.

### SUMMARY

Accordingly, an objective of the instant disclosure is to provide a liquid crystal display and a driving method of the same, and which drives scanning lines and data lines by a timing controller. The thin-film-transistors (TFTs) share a front transistor to write data to be displayed to the liquid crystal capacitor of each pixel element. When writing the data to the liquid crystal capacitor, the thin-film-transistor (TFT) and the front transistor of the corresponding liquid crystal capacitor are turned on simultaneously. After finishing writing data to the liquid crystal capacitor, the thin-film-transistor (TFT) and the front transistor of the corresponding liquid crystal capacitor are turned on alternately. Therefore, the liquid crystal display and the driving method of the same can reduce the time of the gate of the thin-film-transistor (TFT) being in the negative gate bias stress to achieve de-stress.

An exemplary embodiment of the instant disclosure provides a liquid crystal display. The liquid crystal display includes a plurality of scanning lines, a plurality of data lines, a gate driving circuit, a source driving circuit, and a timing controller. The scanning lines are sequentially arranged in parallel and divided into a plurality of scanning groups. Each scanning group has two scanning lines. The data lines are vertically intersected with the scanning lines. A crossing of each data line and each scanning line configures a pixel element. The gate driving circuit is electrically connected to the scanning lines. The source driving circuit is electrically connected to the data lines. The timing controller is electrically connected to the scanning lines and the data lines. The timing controller is configured for generating a common voltage periodically. The common voltage has a low-voltage time and a high-voltage time in each period. A data writing period and a de-stress period are defined in the low-voltage time and the high-voltage time. In the data writing period, the timing controller controls the source driving circuit for providing a data signal to each data line and controls the gate driving circuit for sequentially generating a high-voltage signal to each scanning line. The high-voltage signals of two adjacent scanning lines overlap. When the high-voltage signals of two adjacent scanning lines overlap, the timing controller sequentially transmits the data signal to each pixel element. In the de-stress period, the timing controller controls the gate driving circuit for generating a pulse signal to each scanning line continuously, and the pulse signals generated by each scanning line do not overlap.

An exemplary embodiment of the instant disclosure provides a driving method of a liquid crystal display. The liquid crystal display includes a plurality of scanning lines and a plurality of data lines. The scanning lines are sequentially arranged in parallel and divided into a plurality of scanning groups. Each scanning group has two scanning lines. The data lines are vertically intersected with the scanning lines. A crossing of each data line and each scanning line configures a pixel element. The driving method of the liquid crystal display includes the following steps: periodically generating a common voltage, wherein the common voltage has a low-voltage time and a high-voltage time in each period, and a data writing period and a de-stress period are defined in the low-voltage time and the high-voltage time; in the data writing period, providing a data signal to each data line and sequentially generating a high-voltage signal to each scanning line, wherein the high-voltage signals of two adjacent scanning lines overlap, and when the high-voltage signals of two adjacent scanning lines overlap, sequentially transmitting the data signal to each pixel element; and in the de-stress period, generating a pulse signal to each scanning line continuously, wherein the pulse signals generated by each scanning line do not overlap.

To sum up, the exemplary embodiments of the instant disclosure provide a liquid crystal display and a driving method of the same, which can reduce the time of the gate of the thin-film-transistor (TFT) being in the negative gate bias stress, so that the liquid crystal display can achieve the more accurate initial voltage under the lower frame rate operation and can avoid the leakage of data signal stored in the liquid crystal capacitor.

In order to further understand the techniques, means and effects of the present disclosure, the following detailed descriptions and appended drawings are hereby referred to, such that, and through which, the purposes, features and aspects of the instant disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a diagram of a liquid crystal display according to an exemplary embodiment of the instant disclosure.

FIG. 2 is a relationship diagram between a common voltage and a data signal according to an exemplary embodiment of the instant disclosure.

FIG. 3 is a timing diagram of a timing controller driving scanning lines and data lines in the low-voltage time according to an exemplary embodiment of the instant disclosure.

FIG. 4 is a timing diagram of a timing controller driving scanning lines and data lines in the low-voltage time according to another exemplary embodiment of the instant disclosure.

FIG. 5 is a flowchart of a driving method of a liquid crystal display provided to an exemplary embodiment of the instant disclosure.

### DESCRIPTION OF THE EXEMPLARY EMBODIMENTS

Reference will now be made in detail to the exemplary embodiments of the instant disclosure, examples of which are illustrated in the accompanying drawings. However, they may be embodied in different forms and should not be construed as being limited to the embodiments set forth herein. Wherever possible, the same reference numbers are used in the drawings and the description to refer to the same or like parts.

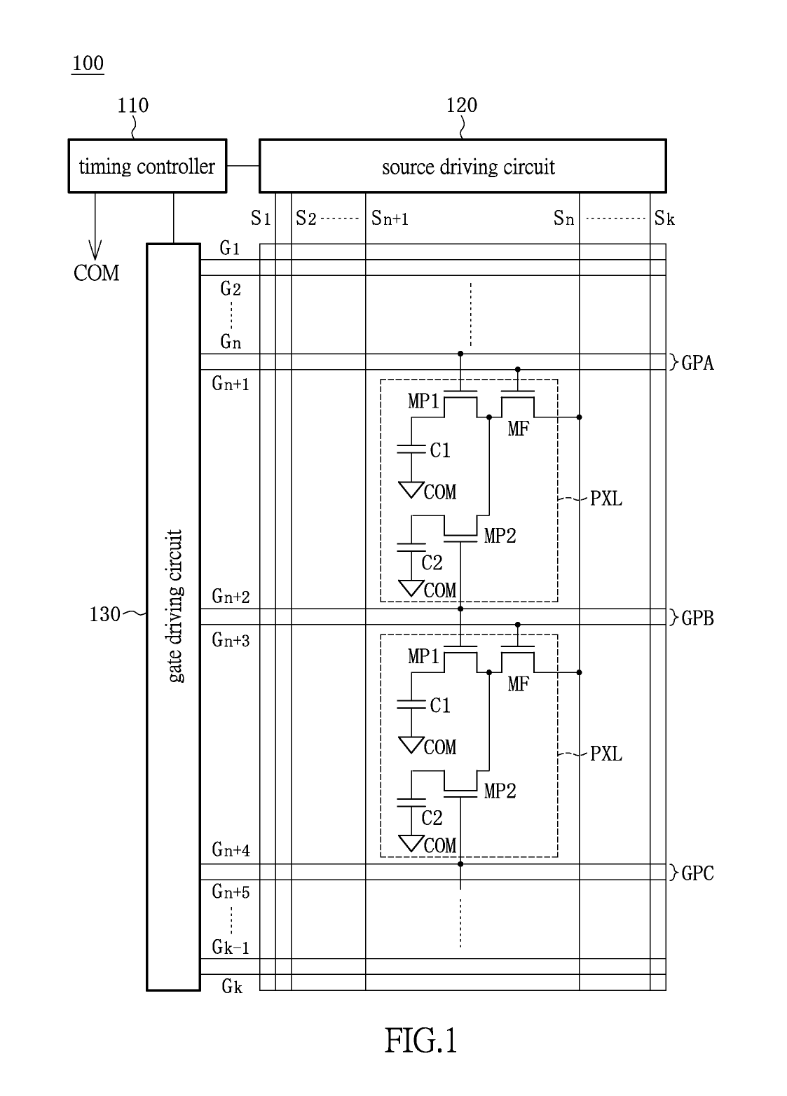

Firstly, please refer to FIG. 1, which shows a diagram of a liquid crystal display according to an exemplary embodiment of the instant disclosure. As shown in FIG. 1, the liquid crystal display (LCD) 100 includes a plurality of scanning lines G1-Gk, a plurality of data lines S1-Sk, a timing controller 110, a source driving circuit 120, and a gate driving circuit 130. The timing controller 110 drives the scanning lines G1-Gk and the data lines S1-Sk through the source driving circuit 120 and the gate driving circuit 130 to display the data (i.e., the frame data) on the display panel of the LCD 100 (not shown in FIGs).

The scanning lines G1-Gk are sequentially arranged in parallel. The data lines S1-Sk are vertically intersected with the scanning lines G1-Gk. More specifically, the scanning lines G1-Gk extending along with a row direction are parallel to each other. The data lines S1-Sk extending along with a column direction are parallel to each other and vertically intersected with the scanning lines G1-Gk. The scanning lines G1-Gk are divided into a plurality of scanning groups. Each scanning group has two scanning lines. For example, the scanning lines G1 and G2 are the same scanning group, the scanning lines Gn and Gn+1 are another scanning group GPA, the scanning lines Gn+2 and Gn+3 are another scanning group GPB, and etc.

The source driving circuit 120 is electrically connected to the data lines S1-Sk to transmit the data to be displayed through the data lines S1-Sk. The gate driving circuit 130 is electrically connected to the scanning lines G1-Gk, and sequentially drives the scanning lines G1-Gk to store the data signal (i.e., the frame data) in the corresponding pixel element PXL. The pixel element PXL is configured at a crossing of each data line S1-Sk and each scanning group to display the data signal on the display panel of the LCD 100. Persons of ordinary skill in this technology field should realize implementation and operation of displaying the data signal stored in the pixel element PXL on the display panel of the LCD 100, and further descriptions are hereby omitted.

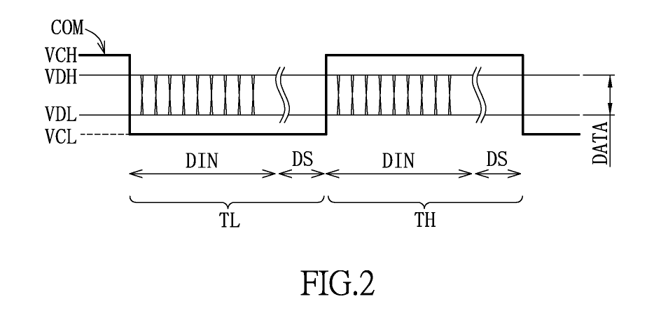

The timing controller 110 is electrically connected to the gate driving circuit 130 and the source driving circuit 120 and periodically generates a common voltage COM. As shown in FIG. 2, the common voltage COM has a low-voltage time TL and a high-voltage time TH in each period. A data writing period DIN and a de-stress period DS are defined in the low-voltage time TL and the high-voltage time TH. In the instant disclosure, the common voltage COM is a square wave. In the low-voltage time TL, the common voltage COM is low-voltage VCL. In the high-voltage time TH, the common voltage COM is high-voltage VCH. The common voltage COM can also be a sine wave, saw-tooth wave, or other type signal. The voltage values of the low-voltage time TL and the high-voltage time TH can also be other voltage values. The instant disclosure is not limited thereto.

As shown in FIG. 2, in the data writing period DIN, the timing controller 110 controls the source driving circuit 120 to provide the data signal DATA to each data line S1-Sk. More specifically, the timing controller 110 controls the source driving circuit 120 in the data writing period DIN of each low-voltage time TL and each high-voltage time TH to transmit the data signal DATA to each data line S1-Sk. In the instant disclosure, the voltage range of the data signal DATA is between the voltage VDL and VDH, and it is not limited thereto. Because the timing controller 110 operating in each low-voltage time TL and each high-voltage time TH are the same, for the convenience in the description, the timing controller 110 operating in the low-voltage time TL is described in the following paragraph.

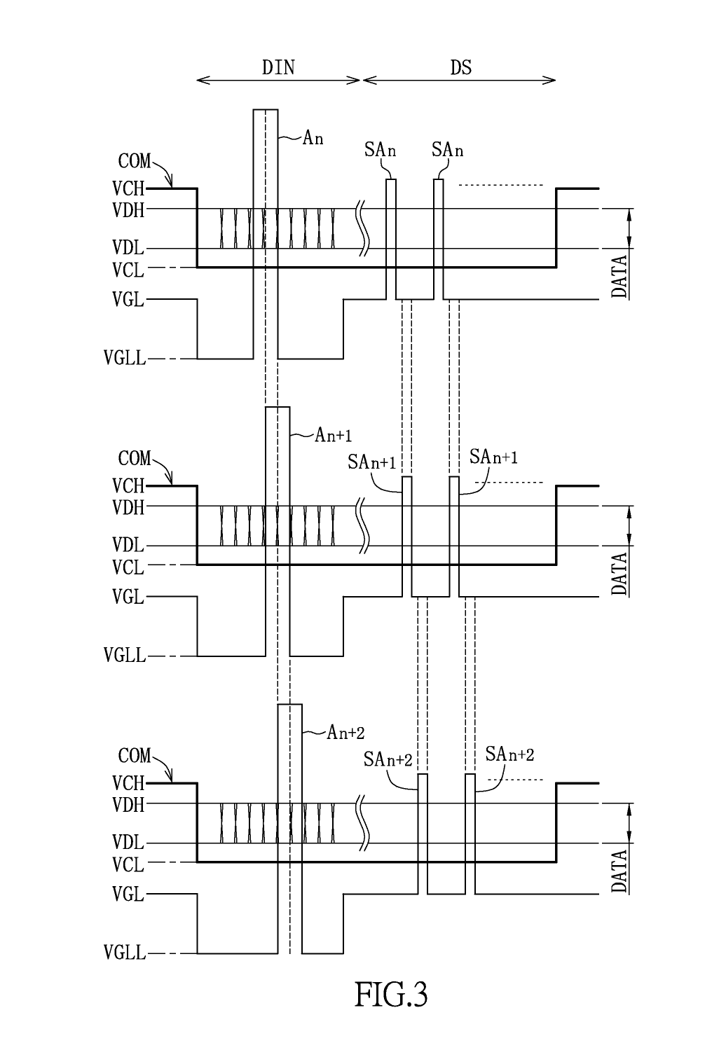

Please refer to FIG. 3, which shows a timing diagram of a timing controller driving scanning lines and data lines in the low-voltage time according to an exemplary embodiment of the instant disclosure. As shown in FIG. 3, in the data writing period DIN, the timing controller 110 controls the gate driving circuit 130 to sequentially generate a high-voltage signal to each scanning line G1-Gk. It is worth to note that the high-voltage signals of two adjacent scanning lines overlap. When the high-voltage signals overlap, the timing controller 110 transmits the data signal DATA to the corresponding pixel element PXL, so that the data signal DATA is sequentially stored in the corresponding pixel element PXL. In the instant disclosure, the high-voltage signal is composed of a high-voltage pulse, and the high-voltage signals of two adjacent scanning lines overlap. The high-voltage signal can also be other type signals, and it is not limited thereto.

As shown in the upper figure of FIG. 3, which shows the timing controller 110 controls gate driving circuit 130 in the data writing period DIN to generate the high-voltage pulse An to the scanning line Gn. As shown in the middle figure of FIG. 3, which shows the timing controller 110 controls gate driving circuit 130 in the data writing period DIN to generate the high-voltage pulse An+1 to the scanning line Gn+1. As shown in the lower figure of FIG. 3, which shows the timing controller 110 controls gate driving circuit 130 in the data writing period DIN to generate the high-voltage pulse An+2 to the scanning line Gn+2. The high-voltage pulses An, An+1 of the adjacent scanning lines Gn, Gn+1 overlap. When the high-voltage pulses An, An+1 overlap, the timing controller 110 transmits the data signal DATA to the corresponding pixel element PXL. The high-voltage pulses An+1, An+2 of the adjacent scanning lines Gn+1, Gn+2 overlap, and when the high-voltage pulses An+1, An+2 overlap, the timing controller 110 transmits the data signal DATA to the corresponding pixel element PXL. Accordingly, the data signal DATA is sequentially stored in the corresponding pixel element PXL.

In the de-stress period, the timing controller 110 controls gate driving circuit 130 to continuously generate a pulse signal to each scanning line G1-Gk, and the pulse signals generated by each scanning line G1-Gk do not overlap. In the instant disclosure, the timing controller 110 can control the gate driving circuit 130 periodically or randomly, to generate the pulse signal to each scanning line G1-Gk. The instant disclosure is not limited thereto.

As shown in the upper figure of FIG. 3, which shows the timing controller 110 controls gate driving circuit 130 in the de-stress period DS to periodically generate the pulse signal SAn to the scanning line Gn. As shown in the middle figure of FIG. 3, which shows the timing controller 110 controls gate driving circuit 130 in the de-stress period DS to periodically generate the pulse signal SAn+1 to the scanning line Gn+1. As shown in the lower figure of FIG. 3, which shows the timing controller 110 controls gate driving circuit 130 in the de-stress period DS to periodically generate the pulse signal SAn+2 to the scanning line Gn+2. Besides, the pulse signals SAn, SAn+1, SAn+2 respectively transmitted from the scanning lines, Gn, Gn+1, Gn+2 do not overlap with each other.

Please return to FIG. 1, more specifically, Each pixel element PXL is electrically connected to the corresponding scanning group, the former scanning line of the next scanning group, and the corresponding data line. For example, in the scanning group GPA, the pixel element PXL configured in a crossing of the scanning group GPA and the data line Sn is electrically connected to the scanning lines Gn and Gn+1 of the scanning group GPA, the scanning line Gn+2 of the scanning group GPB, and the data line Sn. For another example, in the scanning group GPB, the pixel element PXL configured in a crossing of the scanning group GPB and the data line Sn is electrically connected to the scanning lines Gn+2 and Gn+3 of the scanning group GPB, the scanning line Gn+4 of the scanning group GPC, and the data line Sn. The pixel element PXL includes a front transistor MF, a first transistor MP1, a first liquid crystal capacitor C1, a second liquid crystal capacitor C2, and a second transistor MP2.

The front transistor MF has a first end, a second end, and a front control end. The first transistor MP1 has a third end, a fourth end, and a first control end. The first end of the front transistor MF electrically connects to the corresponding data line Sn. The front control end of the front transistor MF electrically connects the scanning line Gn+1 of the corresponding scanning group GPA (i.e., the latter scanning line of the scanning group GPA). The second end of the front transistor MF electrically connects to the third end of the first transistor MP1. The first control end of the first transistor MP1 electrically connects to the scanning line Gn of the scanning group GPA (i.e., the former scanning line of the scanning group GPA). The fourth end of the first transistor MP1 electrically connects to an end of the first liquid crystal capacitor C1. Another end of the first liquid crystal capacitor C1 receives the common voltage COM.

The second transistor MP2 has a fifth end, a sixth end, and a second control end. The fifth end of the second transistor MP2 electrically connects between the second end of the front transistor MF and the third end of the first transistor MP1. The second control end of the second transistor MP2 electrically connects the scanning line Gn+2 of the scanning group GPB (i.e., the former scanning line of the next scanning group GPB). the sixth of the second transistor MP2 electrically connects an end of the second liquid crystal capacitor C2. Another end of the second liquid crystal capacitor C2 receives the common voltage COM.

In conjunction with FIG. 1 and FIG. 3, in the data writing period DIN, when the scanning lines Gn, Gn+1 of the scanning group GPA simultaneously receive the high-voltage signal (i.e., the scanning line Gn receives the high-voltage pulse An and the scanning line Gn+1 receives the high-voltage pulse An+1), the front transistor MF and the first transistor MP1 of the corresponding pixel element PXL of the scanning group GPA are simultaneously turned on, to store the data signal DATA in the first liquid crystal capacitor C1. When the scanning line Gn+1 of the scanning group GPA (i.e., the latter scanning line of the scanning group GPA) and the scanning line Gn+2 of the scanning group GPB (i.e., the former scanning line of the scanning group GPB) simultaneously receive the high-voltage signal (i.e., the scanning line Gn+1 receives the high-voltage pulse An+1 and the scanning line Gn+2 receives the high-voltage pulse An+2), the front transistor MF and the second transistor MP2 of the corresponding pixel element PXL of the scanning group GPA are simultaneously turned on, to store the data signal DATA in the second liquid crystal capacitor C2.

In the de-stress period DS, when the scanning lines Gn and Gn+1 of the scanning group GPA and the scanning line Gn+2 of the scanning group GPB (i.e., the scanning lines electrically connected to the corresponding pixel element PXL of the scanning group GPA) respectively receive the pulse signal (i.e., the scanning line Gn receives the pulse signal SAn, the scanning line Gn+1 receives the pulse signal SAn+1, and the scanning line Gn+2 receives the pulse signal SAn+2), the front transistor MF, the first transistor MP1, and the second transistor MP2 are alternately turned on according to the received pulse signal. Because the front transistor MF, the first transistor MP1, and the second transistor MP2 of each pixel element PXL are not simultaneously turned on and continuously turned on or off in the de-stress period DS, the data signal DATA stored in the first liquid crystal capacitor C1 and the second liquid crystal capacitor C2 does not lose, and the gate of the front transistor MF, the gate of the first transistor MP1, and the gate of the second transistor MP2 do not stay at the negative gate bias stress for a long time (i.e., the stress during the gate-source voltage VGS being less than the threshold voltage VT).

From the aforementioned description, in the data writing period DIN, the timing controller 110 sequentially stores the data signal DATA in the first liquid crystal capacitor C1 and the second liquid crystal capacitor C2 of each pixel element PXL through the scanning lines G1-Gk, to display the data signal DATA on the display panel of the LCD 100. In the de-stress period DS, the timing controller 110 controls the front transistor MF, the first transistor MP1, and the second transistor MP2 of each pixel element PXL to alternately and continuously turn on the above-mentioned transistors of each pixel element PXL through the scanning lines G1-Gk, so that the first liquid crystal capacitor C1 and the second liquid crystal capacitor C2 of each pixel element PXL can make sure the gate of the front transistor MF, the gate of the first transistor MP1, and the gate of the second transistor MP2 do not stay at the negative gate bias stress for a long time under the situation of keeping the data signal DATA. Accordingly, the LCD 100 can achieve the more accurate initial voltage under the lower frame rate operation and can avoid the leakage of data signal DATA stored in the first liquid crystal capacitor C1 and the second liquid crystal capacitor C2.

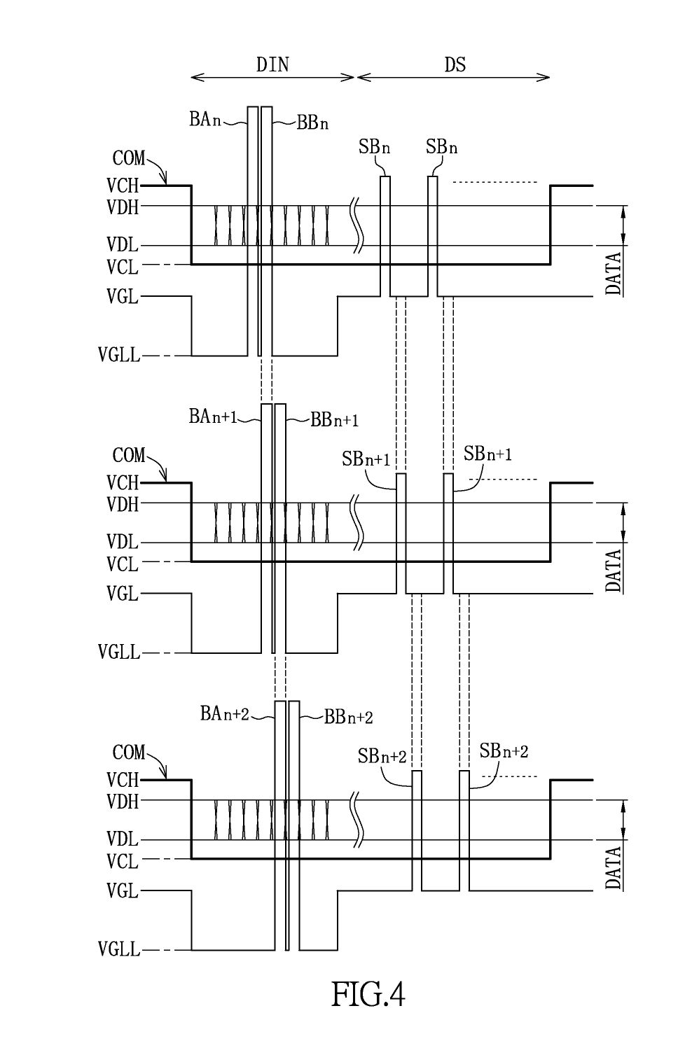

Next, please refer to FIG. 4, which shows a timing diagram of a timing controller driving scanning lines and data lines in the low-voltage time according to another exemplary embodiment of the instant disclosure. Compared with the LCD 100 of the aforementioned embodiments, the difference of the LCD of the instant disclosure is that in the data writing period DIN, the high-voltage signal generated by the gate driving circuit 130 controlled by the timing controller 110 is composed of two high-voltage pulses. The two high-voltage pulses are respectively defined as a first high-voltage pulse and a second high-voltage pulse. In two adjacent scanning lines G1-Gk, the second high-voltage pulse of the former scanning line overlaps the first high-voltage pulse of the latter scanning line.

As shown in the upper figure of FIG. 4, the timing controller 110 controls the gate driving circuit 130 in the data writing period DIN to generate the first high-voltage pulse BAn and the second high-voltage pulse BBn (i.e., two high-voltage pulses) to the scanning line Gn. As shown in the middle figure of FIG. 4, the timing controller 110 controls the date driving circuit 130 in the data writing period DIN to generate the first high-voltage pulse BAn+1 and the second high-voltage pulse BBn+1 (i.e., two high-voltage pulses) to the scanning line Gn+1. As shown in the lower figure of FIG. 4, the timing controller 110 controls the gate driving circuit 130 in the data writing period DIN to generate the first high-voltage pulse BAn+2 and the second high-voltage pulse BBn+2 (i.e., two high-voltage pulses) to the scanning line Gn+2. In the adjacent scanning lines Gn and Gn+1, the second high-voltage pulse BBn of the scanning line Gn (i.e., the former scanning line) overlaps the first high-voltage pulse BAn+1 of the scanning line Gn+1 (i.e., the latter scanning line), and when the second high-voltage pulse BBn overlaps the first high-voltage pulse BAn+1, the timing controller 110 transmits the data signal DATA to the corresponding pixel element PXL. In the adjacent scanning lines Gn+1 and Gn+2, the second high-voltage pulse BBn+1 of the scanning line Gn+1 (i.e., the former scanning line) overlaps the first high-voltage pulse BAn+2 of the scanning line Gn+2 (i.e., the latter scanning line), and when the second high-voltage pulse BBn+1 overlaps the first high-voltage pulse BAn+2, the timing controller 110 transmits the data signal DATA to the corresponding pixel element PXL.

Therefore, in the data writing period DIN, when the scanning lines Gn and Gn+1 of the scanning group GPA simultaneously receive the high-voltage signal (i.e., the scanning line Gn receives the second high-voltage pulse BBn and the scanning line Gn+1 receives the first high-voltage pulse BAn+1), the front transistor MF and the first transistor MP1 of the corresponding pixel element PXL of the scanning group GPA are simultaneously turned on, to store the data signal DATA in the first liquid crystal capacitor C1. When the scanning line Gn+1 of the scanning group GPA (i.e., the latter scanning line of the scanning group GPA) and the scanning line Gn+2 of the scanning group GPB (i.e., the former scanning line of the scanning group GPB) simultaneously receive the high-voltage signal (i.e., the scanning line Gn+1 receives the second high-voltage pulse BBn+1 and the scanning line Gn+2 receives the first high-voltage pulse BAn+2), the front transistor MF and the second transistor MP2 of the corresponding pixel element PXL of the scanning group GPA are simultaneously turned on, to store the data signal DATA in the second liquid crystal capacitor C2. From FIGS. 1-4, each pixel element PXL can also have more than or equal to three liquid crystal capacitors. Each liquid crystal capacitor connects in series with the corresponding transistor, and respectively and the electrically connects to a front transistor. Meanwhile, the thin-film-transistors (TFTs) share a front transistor and the timing controller 110 drives the corresponding scanning line and the corresponding data line to write data to be displayed to the liquid crystal capacitor of each pixel element. When writing the data to the liquid crystal capacitor of one pixel element, the timing controller 110 drives the corresponding scanning line and the data line to simultaneously turn on the transistor connected in series to the corresponding liquid crystal capacitor and the front transistor. After finishing writing data to the liquid crystal capacitor, the transistors connected in series to all liquid crystal capacitors and the front transistor of the pixel element are turned on alternately. For example, when the scanning lines Gn and Gn+1 of the scanning group GPA and the scanning line Gn+2 of the scanning group GPB (i.e., the scanning lines electrically connected to the corresponding pixel element PXL of the scanning group GPA) respectively receive the pulse signal (i.e., the scanning line Gn receives the pulse signal SBn, the scanning line Gn+1 receives the pulse signal SBn+1, and the scanning line Gn+2 receives the pulse signal SBn+2), the front transistor MF, a first transistor MP1, and the second transistor MP2 are alternately turned on according to the received pulse signal. With respect to connection relationships and operations of the liquid crystal capacitors, the transistors, a front transistor, scanning lines, and the data lines can be inferred by FIG. 1-4, and further descriptions are hereby omitted.

Accordingly, the liquid crystal display can reduce the time of the gate of the thin-film-transistor (TFT) being in the negative gate bias stress to achieve de-stress.

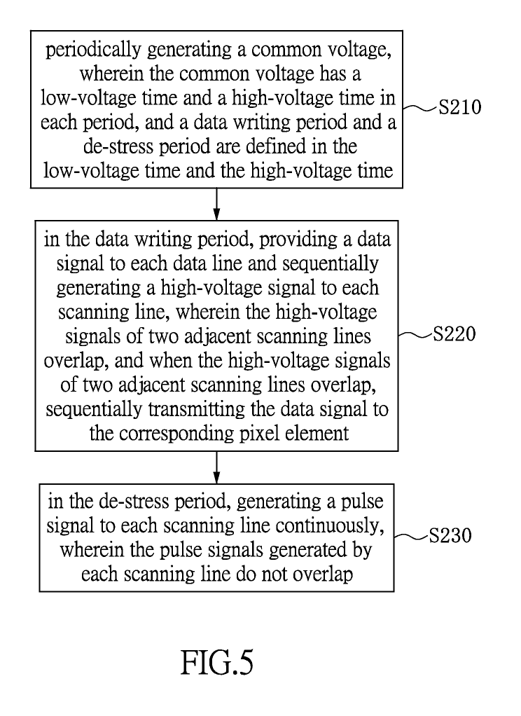

From the aforementioned exemplary embodiments, the instant disclosure may generalize a driving method, which is adapted for the aforementioned liquid crystal display. Please refer to FIG. 5 in conjunction with FIGS. 1-3. Firstly, the liquid crystal display 100 periodically generates the common voltage COM. The common voltage COM has a low-voltage time TL and a high-voltage time TH in each period. A data writing period DIN and a de-stress period DS are defined in the low-voltage time TL and the high-voltage time TH (step S210).

In the data writing period DIN, the liquid crystal display 100 provides the data signal DATA to each data line S1-Sk, and sequentially generates high-voltage signal to each scanning line G1-Gk. The high-voltages of two adjacent scanning lines G1-Gk overlap. When the high-voltages signals of two adjacent scanning lines overlap, the liquid crystal display 100 sequentially transmits the data signal DATA to each pixel element PXL (step S220). With respect to the liquid crystal display 100 driving each data line S1-Sk, each scanning line G1-Gk, and each pixel element PXL in data writing period DIN are illustrated in the aforementioned exemplary embodiments, so their detailed description is omitted.

In the data writing period DS, the liquid crystal display 100 generates a pulse signal to each scanning line G1-Gk continuously, and the pulse signals generated by each scanning line G1-Gk do not overlap (step S230). Similarly, with respect to the liquid crystal display 100 driving each data line S1-Sk, each scanning line G1-Gk, and each pixel element PXL in de-stress period DS are illustrated in the aforementioned exemplary embodiments, so their detailed description is omitted.

In summary, the exemplary embodiments of the instant disclosure provide a liquid crystal display and a driving method of the same, which can reduce the time of the gate of the thin-film-transistor (TFT) being in the negative gate bias stress, so that the liquid crystal display can achieve the more accurate initial voltage under the lower frame rate operation and can avoid the leakage of data signal stored in the liquid crystal capacitor.

The above-mentioned descriptions represent merely the exemplary embodiment of the instant disclosure, without any intention to limit the scope of the instant disclosure thereto. Various equivalent changes, alterations or modifications based on the claims of instant disclosure are all consequently viewed as being embraced by the scope of the instant disclosure.

What is claimed is:

1. A liquid crystal display, comprising:
a plurality of scanning lines, sequentially arranged in parallel and being divided into a plurality of scanning groups, wherein each scanning group has two scanning lines;
a plurality of data lines, vertically intersected with the scanning lines, wherein a crossing of each data line and each scanning line configures a pixel element;
a gate driving circuit, electrically connected to the scanning lines;
a source driving circuit, electrically connected to the data lines; and
a timing controller, electrically connected to the scanning lines and the data lines, and configured for generating a common voltage periodically, wherein the common voltage has a low-voltage time and a high-voltage time in each period, and a data writing period and a de-stress period are defined in the low-voltage time and the high-voltage time;
wherein in the data writing period, the timing controller controls the source driving circuit for providing a data signal to each data line and controls the gate driving circuit for sequentially generating a high-voltage signal to each scanning line, the high-voltage signals of two adjacent scanning lines overlap, and when the high-voltage signals of two adjacent scanning lines overlap, the timing controller sequentially transmits the data signal to each pixel element;
wherein in the de-stress period, the timing controller controls the gate driving circuit for generating a pulse signal to each scanning line continuously, and the pulse signals generated by each scanning line do not overlap.

2. The liquid crystal display according to claim 1, wherein the high-voltage signal is composed of a high-voltage pulse, and the high-voltage signals of two adjacent scanning lines overlap.

3. The liquid crystal display according to claim 1, wherein the high-voltage signal is composed of two high-voltage pulses, which are respectively defined as a first high-voltage pulse and a second high-voltage pulse, and the second high-voltage pulse of the former scanning line overlaps the first high-voltage pulse of the latter scanning line in two adjacent scanning lines.

4. The liquid crystal display according to claim 1, wherein each pixel element electrically connects to the corresponding scanning group, the former scanning line of the next scanning group, and the corresponding data line, and each pixel element comprises:
a front transistor, having a first end, a second end, and a front control end, the first end electrically connected to the corresponding data line, and the front control end electrically connected to the latter scanning line of the corresponding scanning group;
a first transistor, having a third end, a fourth end, and a first control end, the third end electrically connected to the second end, and the first control end electrically connected to former scanning line of the corresponding scanning group;
a first liquid crystal capacitor, an end of the first liquid crystal capacitor electrically connected to the fourth end, and another end of the first liquid crystal capacitor configured for receiving the common voltage;
a second transistor, having a fifth end, a sixth end, and a second control end, the fifth end electrically connected between the second end and the third end, and the second control end electrically connected the former scanning line of the next scanning group; and
a second liquid crystal capacitor, an end of the second liquid crystal capacitor electrically connected to the sixth end, and another end of the second liquid crystal capacitor configured for receiving the common voltage.

5. The liquid crystal display according to claim 4, wherein when the scanning lines of the scanning group corresponding to the pixel element simultaneously receive the high-voltage signal, the front transistor and the first transistor of the pixel element are simultaneously turned on for storing the data signal to the first liquid crystal capacitor, and when the latter scanning line of the scanning group and the former scanning line of the next scanning group corresponding to the pixel element simultaneously receive the high-voltage signal, the front transistor and the second transistor of the pixel element are simultaneously turned on for storing the data signal to the second liquid crystal capacitor.

6. The liquid crystal display according to claim 4, wherein when the scanning lines corresponding to the pixel element respectively receive the pulse signal, the front transistor, the first transistor, and the second transistor are alternately turned on according to the received pulse signal.

7. A driving method of a liquid crystal display, the liquid crystal display comprising a plurality of scanning lines and a plurality of data lines, the scanning lines sequentially arranged in parallel and being divided into a plurality of scanning groups, each scanning group having two scanning lines, the data lines vertically intersected with the scanning lines, a crossing of each data line and each scanning line configuring a pixel element, and the driving method of the liquid crystal display comprising:
periodically generating a common voltage, wherein the common voltage has a low-voltage time and a high-voltage time in each period, and a data writing period and a de-stress period are defined in the low-voltage time and the high-voltage time;
in the data writing period, providing a data signal to each data line and sequentially generating a high-voltage signal to each scanning line, wherein the high-voltage signals of two adjacent scanning lines overlap, and when the high-voltage signals of two adjacent scanning lines overlap, sequentially transmitting the data signal to each pixel element; and
in the de-stress period, generating a pulse signal to each scanning line continuously, wherein the pulse signals generated by each scanning line do not overlap.

8. The driving method according to claim 7, wherein the high-voltage signal is composed of a high-voltage pulse, and the high-voltage signals of two adjacent scanning lines overlap.

9. The driving method according to claim 7, wherein the high-voltage signal is composed of two high-voltage pulses, which are respectively defined as a first high-voltage pulse and a second high-voltage pulse, and the second high-voltage pulse of the former scanning line overlaps the first high-voltage pulse of the latter scanning line in two adjacent scanning lines.

10. The driving method according to claim 7, wherein each pixel element electrically connects to the corresponding scanning group, the former scanning line of the next scanning group, and the corresponding data line, and each pixel element comprises:
a front transistor, having a first end, a second end, and a front control end, the first end electrically connected to the corresponding data line, and the front control end electrically connected to the latter scanning line of the corresponding scanning group;
a first transistor, having a third end, a fourth end, and a first control end, the third end electrically connected to the second end, and the first control end electrically connected to former scanning line of the corresponding scanning group;
a first liquid crystal capacitor, an end of the first liquid crystal capacitor electrically connected to the fourth end, and another end of the first liquid crystal capacitor configured for receiving the common voltage;
a second transistor, having a fifth end, a sixth end, and a second control end, the fifth end electrically connected between the second end and the third end, and the second control end electrically connected the former scanning line of the next scanning group; and
a second liquid crystal capacitor, an end of the second liquid crystal capacitor electrically connected to the sixth end, and another end of the second liquid crystal capacitor configured for receiving the common voltage.

11. The driving method according to claim 10, wherein when the scanning lines of the scanning group corresponding to the pixel element simultaneously receive the high-voltage signal, the front transistor and the first transistor of the pixel element are simultaneously turned on for storing the data signal to the first liquid crystal capacitor, and when the latter scanning line of the scanning group and the former scanning line of the next scanning group corresponding to the pixel element simultaneously receive the high-voltage signal, the front transistor and the second transistor of the pixel element are simultaneously turned on for storing the data signal to the second liquid crystal capacitor.

12. The driving method according to claim 10, wherein when the scanning lines corresponding to the pixel element respectively receive the pulse signal, the front transistor, the first transistor, and the second transistor are alternately turned on according to the received pulse signal.
